(19) United States
(12) Patent Application Publication
(10) Pub. No.: US 2021/0061522 A1
(43) Pub. Date: Mar. 4, 2021

(54) SYSTEM AND METHOD FOR ADJUSTABLE COVER FOR STORAGE CONTAINER

(71) Applicant: Shujan Bertrand, San Francisco, CA (US)

(72) Inventor: Shujan Bertrand, San Francisco, CA (US)

(21) Appl. No.: 17/010,805

(22) Filed: Sep. 2, 2020

Related U.S. Application Data
(60) Provisional application No. 62/894,957, filed on Sep. 2, 2019.

(51) Int. Cl. B65D 33/28; B65D 30/00; B65B 7/06

(52) U.S. Cl. CPC B65D 33/28; B65B 7/06; B65D 29/00

(57) ABSTRACT

An adjustable cover by which a user may secure to a storage container base that is not only safe for the environment but also durable and provides a proper fit to secure substances such as food or liquids inside of the storage container, the adjustable cover including a reusable cotton cover having drawstring ties for secure wrapping around various shapes and sized storage container bases.

### CROSS REFERENCE TO RELATED APPLICATIONS

The following is a non-provisional patent application claiming priority to U.S. provisional patent application 62/894,957 filed on Sep. 2, 2019, which is incorporated by reference in its entirety.

### FIELD OF THE DISCLOSURE

This invention relates generally to kitchen utensils and dishware for use in storing food items, and more particularly to a reusable adjustable cover designed to adapt to various types of dishware.

### BACKGROUND

Potlucks, parties, and other events are typified by an assortment of foods served in communally accessible dishware and containers. For example, since the 1940s, Tupperware has been a staple for kitchen essentials, designed to store and prolong the life of many foods as well as liquids such as oils and sugary fluids. These food storage containers are typically comprised of rigid or flexible, resilient plastic components having a base and a lid that attaches to the top of the base to seal the food storage container. Each individual container includes a corresponding lid sized to fit the specific individual container. Users often store empty containers while not in use in a kitchen cabinet or pantry. When not being used, the lids may become easily separated from their associated individual container requiring the user to spend more time finding the correct lid for the associated container.

The standard plastics found in lids are also never truly biodegradable and only have a limited lifetime of uses before needing to be replaced. Other food storage containers require single use plastic, foil, or elastic bands which may be relatively toxic, thus further polluting the environment. Accordingly, there exists a need for a food storage container that has a longer lifespan than the commonly used materials today that is not toxic and provides a secure fit when attached to the food storage container.

### SUMMARY

The disclosure herein relates to a system for storage of substances comprising a storage container and an adjustable cover, the adjustable cover having a drawstring, the adjustable cover connected to the base wherein the drawstring is configured to be pulled taut securing the adjustable cover to the base, a band assembly having a portion of the adjustable cover article folded over upon itself wherein the edges folded over are sewn to a remaining portion, the edges sewn a second time to finish with a flat edge forming a drawstring channel, the drawstring channel having an open first end and a second open end, the drawstring attached to the drawstring channel, the adjustable cover reversible wherein when turned inside out the cover is configured to be pulled taut before being tied into a knot creating a pouch to secure the substances inside.

The disclosure herein also relates to a system for storage of substances comprising an adjustable cover, the adjustable cover having a drawstring, the adjustable cover connected to the base wherein the drawstring is configured to be pulled taut securing the adjustable cover to the base wherein when turned inside out the cover is configured to be pulled taut before being tied into a knot creating a pouch to secure the substances inside, a band assembly having a portion of the adjustable cover article folded over upon itself wherein the edges folded over are sewn to a remaining portion, the edges sewn a second time to finish with a flat edge forming a drawstring channel, the drawstring channel having an open first end and a second open end, the drawstring attached to the drawstring channel, the adjustable cover reversible wherein when turned inside out the cover is configured to be pulled taut before being tied into a knot creating a pouch to secure the substances inside, further comprising a storage container with a bottom surface; sidewalls extending from a perimeter of the bottom surface, the sidewalls terminating at a top edge that defines an opening and a flange extending radially outward from the sidewalls below and spaced from the top edge.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of select embodiments and not all possible implementations and are not intended to limit the scope of the present disclosure.

FIG. 1 is a top perspective view of an embodiment for an adjustable cover storage container system with an adjustable cover fastened to a storage container.

FIG. 2 is a bottom perspective view of an embodiment for an adjustable cover of an adjustable cover storage container system.

FIG. 3 is a top perspective view of an embodiment for an adjustable cover storage container system.

FIG. 4 is a bottom view of an embodiment for an adjustable cover of an adjustable cover storage container system.

FIG. 5 is a perspective view of an embodiment of the adjustable cover acting a bag.

FIG. 6 is another perspective view of the adjustable cover in FIG. 5 acting a bag.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and the upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present invention is directed to an apparatus by which a user may secure to a storage container base that is not only safe for the environment but also durable and provides a proper fit to secure substances such as food or liquids inside of the storage container base. The invention includes a reusable cotton cover having drawstring ties for secure wrapping around various shapes and sized storage container bases. The adjustable cotton cover is designed to keep food warm on the counter or fresher in the refrigerator. The drawstring ties eliminate toxic elastic bands and provide a more secure attachment of the reusable cotton cover to the storage container base. The adjustable cotton cover may be reused and machine washed cold to help save energy and sustain the life of the cotton cover. Currently there is a great need for alternative covers because of the dangers of plastic such that the cotton covers will soon become as essential as kitchen towels or cloth napkins.

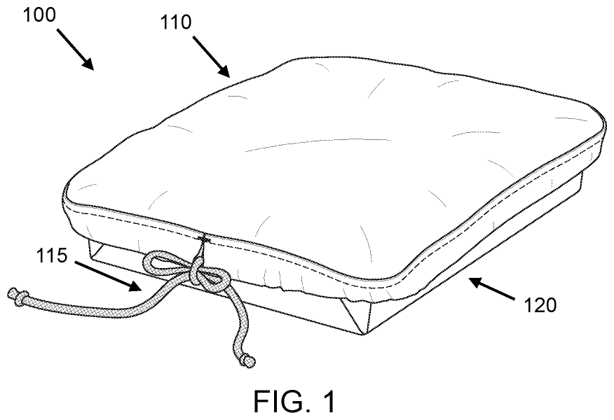

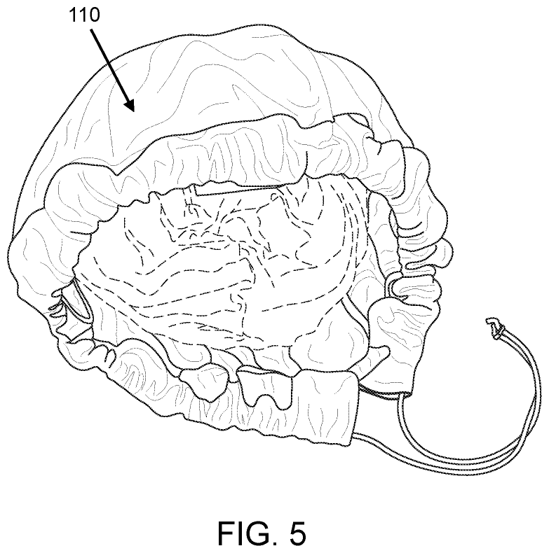

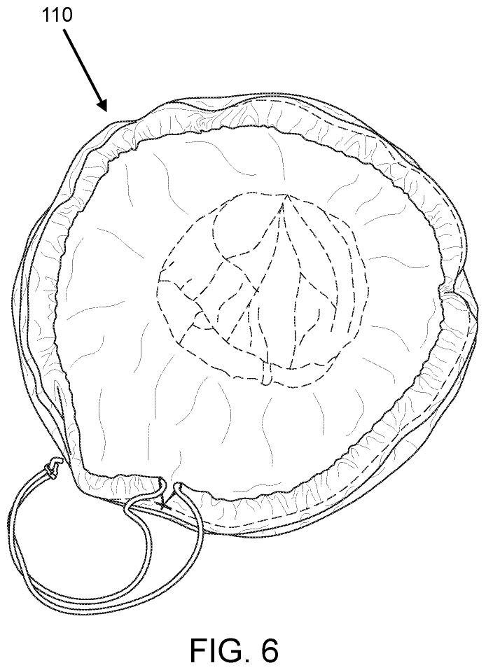

Referring initially to FIG. 1, a perspective view of an embodiment for an adjustable cover storage container 100 is shown, having an adjustable cover such as adjustable cover 110 and a storage container base such as storage container base 120. Storage container base 120 may be included in a set of multiple container bases creating an assembly of storage container bases 120 that may be used with one adjustable cover 110 or a plurality of adjustable covers 110. Adjustable cover storage container 100 is not limited to only a single adjustable cover storage container 100 or to a specific number of adjustable cover storage containers 100. In some non-limiting embodiments there may be an assembly of adjustable cover storage containers 100 including multiple storage container bases 120 of the same size storage capacity or different storage capacity such as a cup, pint, or quart storage capacity. In some embodiments multiple storage container bases 120 may have the same size and shape opening so that a single adjustable cover 110 may be used while in other embodiments multiple adjustable covers 110 of different shapes and sizes may be used such as round or circular as illustrated in FIG. 5 and FIG. 6. In another embodiment, storage container bases may come in 5, 6, 7, 8, 9, 10, and 13-5 inches in length having a rectangular or round shape.

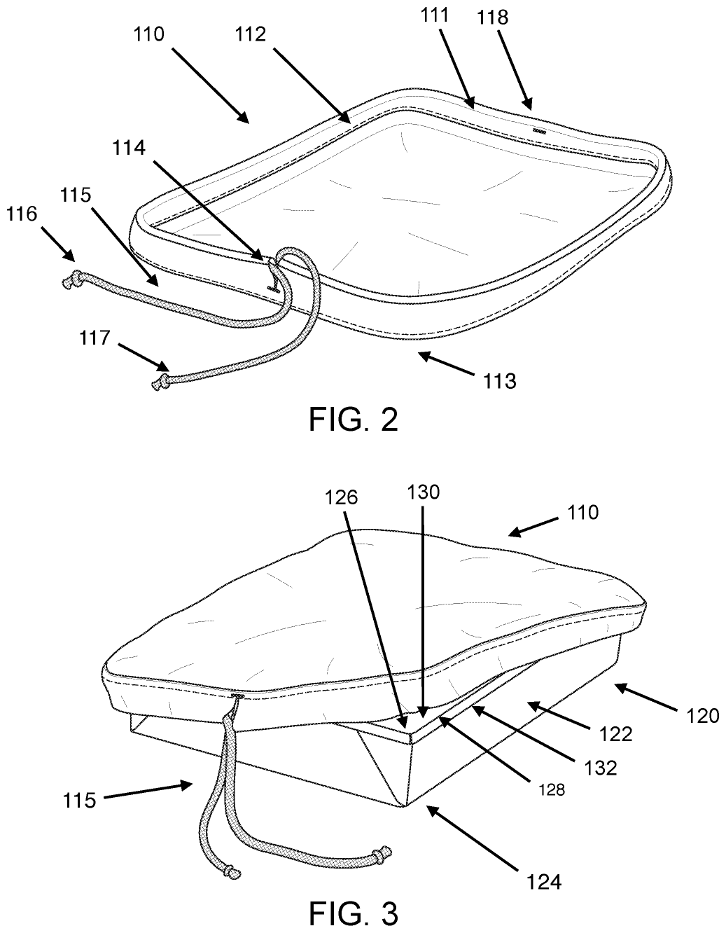

Referring to FIG. 2, a perspective view for adjustable cover 110 is shown. Adjustable cover 110 may be made of a cotton, nylon, polyester, other eco-materially safe blends or any fabric that may be properly sewn with the purpose of the present invention. Adjustable cover 110 may vary in size, shape, width and thickness. For example, adjustable cover 110 may be a round or rectangular fabric cut piece. Adjustable cover 110 may comprise a band assembly such as band assembly 111 which may be constructed integral during the time of fabrication or in some embodiments may be retrofitted to an existing article that does not have a band assembly at the edges of the article (the perimeter of a round or rectangular article). Band assembly 111 includes a portion of the existing article folded over upon itself whereby the edges folded over may be sewn to the remaining portion, creating a band that may be but not limited to 2.75″ in length. The joined edges may be sewn again to finish with a flat edge forming a drawstring channel such as drawstring channel 112, having an open first end such as first open end 113 and a second open end such as second open end 114. Drawstring channel 112 may be also be secured by any form of stitching or other fastening methods known by those of ordinary skill in the art.

A drawstring such as drawstring 115 may be threaded, looped, or otherwise attached to drawstring channel 112 by fastener 118 whereby drawstring 115 cannot be removed from the channel. In some embodiments fastener 118 may be in a removable engagement with drawstring 115 allowing for drawstring 115 to be removed from drawstring channel 112 so that other drawstrings may be implemented. Drawstring 115 may include a plurality of strands of twisted cotton fiber, nylon, or polyester, and a first tab such as first tab 116 and a second tab such as second tab 117. Tabs 116 and 117 are preferably a piece of thermoplastic material formed at and encompassing a length at opposing free ends of drawstring 115. The drawstring 115, once threaded or looped through drawstring channel 112, has sufficient length to allow tabs 116 and 117 and a length of drawstring 115 extending out of the first open end 113 and second open end 114 to be tied by a user. Either tab 116 or 117 may be initially fitted into the first open end 113 then looped through drawstring channel 112 until tab 116 or 117 emerges from second open end 114 of said drawstring channel 112.

Referring to FIG. 3, a perspective view for adjustable cover storage container 110 is shown. Storage container base 120 may have a continuous perimeter sidewall such as sidewall 122 and a bottom such as bottom 124 that defines an interior storage space such as interior storage space 126. Interior storage space 126 creates storage area that may be used for keeping food such as fruits, vegetables, salads, meat, fish as well as liquids such as smoothies, carbonated beverages, or alcoholic drinks secured for extended periods of time either in a refrigerator, a closet or pantry, or during transportation. In this embodiment, sidewall 122 and bottom 124 form a substantially four-sided shape (generally square or rectangle shape) with rounded corners. However, storage container base 120 is not limited to a specific perimeter shape or overall contour and other shapes and configurations may be used such as but not limited to a round or circular, hexagonal, triangular, octagonal storage container base 120.

Sidewall 122 may extend upwardly and generally outwardly from a perimeter of bottom 124 and terminates at a top edge such as top edge 128 that defines an opening such as opening 130. A flange such as flange 132 may extend radially outward from sidewall 122 below and spaced from the top edge 128 to assist a user in carrying storage container base 120 during use as well as assisting in the secure connection between adjustable cover 110 and storage container base 120.

In some embodiments, storage container base 120 may have a foot or ribbing that extends downward from bottom 124 wherein the foot or ribbing provides a resting surface on which bottom 124 can rest during use and while being stored so as to protect the integrity of storage container base 120 for longer periods of time. The size, positioning, and shape of the foot or ribbing may vary depending on the need and circumstance.

Storage container base 120 may be formed of any suitable material and fabricated from any likewise suitable manufacturing process such as but not limited high-density polyethylene (HDPE, or plastic #2), low-density polyethylene (LDPE, or plastic #4) and polypropylene (PP, or plastic #5). Storage container base 120 may be formed from a transparent, translucent, semi-transparent, or opaque material and can be formed in any desirable color. For example, color may be chosen based on personal preference or to help users identify a specific category or variety of food or liquid that may be stored inside of storage container base 120.

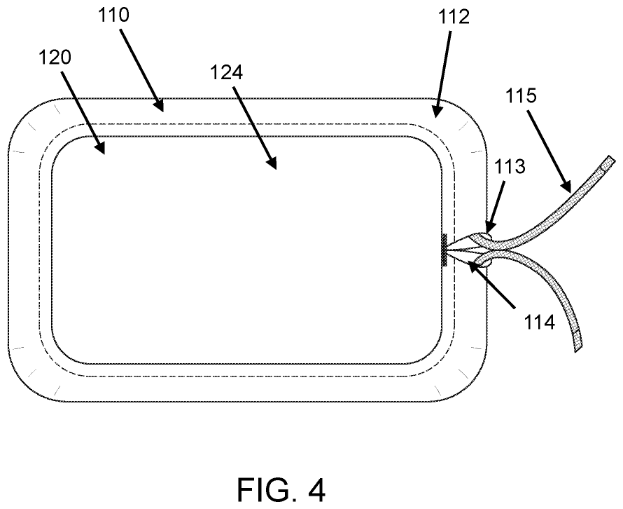

Referring to FIG. 4, a bottom view for adjustable cover storage container 110 is shown. Drawstring 115 may be pulled taut before being tied into a knot. The tension by drawstring 115 on or near top edge 128 of storage container base 120 assists in securing adjustable cover 110 to storage container base 120. In a preferred embodiment, drawstring 115 is pulled taut and tied in a bow knot in front of adjustable cover 110. When tied together, a different knot may also be used. In some embodiments, drawstring 115 need not be tied in a knot but instead may be tied or secured to one or more anchoring points outside or inside of the adjustable cover 110 or storage container base 120.

Adjustable cover 110 is completely reversible, and when adjustable cover 110 normally positioned or turned inside out, it may be used to store substances including food items such as a sandwiches during transportation or when storing as illustrated in FIG. 5 and FIG. 6 with a round shaped adjustable cover 110. For some substances, drawstring 115 may be pulled taut before being tied into a knot creating a pouch to secure the substances inside.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A system for storage of substances comprising:
a storage container;
an adjustable cover, the adjustable cover having a drawstring, the adjustable cover connected to the base wherein the drawstring is configured to be pulled taut securing the adjustable cover to the base.

2. The system of claim 1, further comprising a band assembly having a portion of the adjustable cover article folded over upon itself wherein edges folded over are sewn to a remaining portion.

3. The system of claim 2, the edges sewn a second time to finish with a flat edge forming a drawstring channel, the drawstring channel having an open first end and a second open end, the drawstring attached to the drawstring channel.

4. The system of claim 3, the drawstring made of a plurality of strands of twisted fibers.

5. The system of claim 4, the drawstring having a first and second tab.

6. The system of claim 5, the adjustable cover made of cotton.

7. The system of claim 5, the adjustable cover made of polyester.

8. The system of claim 5, the adjustable cover made of nylon.

9. The system of claim 5, the adjustable cover reversible wherein when turned inside out the cover is configured to be pulled taut before being tied into a knot creating a pouch to secure the substances inside.

10. A system for storage of substances comprising:
an adjustable cover, the adjustable cover having a drawstring, the adjustable cover connected to a base wherein the drawstring is configured to be pulled taut securing the adjustable cover to the base wherein when turned inside out the cover is configured to be pulled taut before being tied into a knot creating a pouch to secure the substances inside.

11. The system of claim 10, further comprising a band assembly having a portion of the adjustable cover article folded over upon itself wherein edges folded over are sewn to a remaining portion.

12. The system of claim 11, the edges sewn a second time to finish with a flat edge forming a drawstring channel, the drawstring channel having an open first end and a second open end, the drawstring removably attached to the drawstring channel.

13. The system of claim 12, the drawstring made of a plurality of strands of twisted fibers.

14. The system of claim 13, the drawstring having a first and second tab whereby the first and second tab extend out from the drawstring channel.

15. The system of claim 14, the adjustable cover reversible wherein when turned inside out, the adjustable cover is configured to be pulled taut before being tied into a knot creating a pouch to secure the substances inside.

16. The system of claim 15, further comprising a storage container with a bottom surface and sidewalls extending from a perimeter of the bottom surface, the sidewalls terminating a top edge that defines an opening.

17. The system of claim 16, further comprising a flange extending radially outward from the sidewalls below and spaced from the top edge.

18. The system of claim 17, further comprising a second storage container and a second adjustable cover of a different size or shape than the storage container and the adjustable cover

19. The system of claim 10, the adjustable cover rectangular or circular in shape.

20. A method for storage of substances, the method comprising:
pulling a drawstring on an adjustable cover taut creating a pouch to secure a substance inside, the adjustable cover having a band assembly having a portion of the adjustable cover article folded over upon itself wherein edges folded over are sewn to a remaining portion, the edges sewn a second time to finish with a flat edge forming a drawstring channel, the drawstring channel having an open first end and a second open end, the drawstring attached to the drawstring channel;
tying the drawstring on the adjustable cover into a knot, the drawstring made of a plurality of strands of twisted fibers, the drawstring having a first tab and second tab at opposite ends;
untying the drawstring on the adjustable cover;
loosening the drawstring on the adjustable cover and removing the substance inside;
pulling the drawstring taut on the adjustable cover to cover a base, the adjustable cover positioned over the base; and
tying the drawstring on the adjustable cover into a knot.
